(19) United States
(12) Patent Application Publication
(10) Pub. No.: US 2013/0156877 A1
(43) Pub. Date: Jun. 20, 2013

(54) Dough Extruder

(71) Applicant: Kevin Crane, Orchard Park, NY (US)

(72) Inventor: Kevin Crane, Orchard Park, NY (US)

(73) Assignee: MATTEL, INC., El Segundo, CA (US)

(21) Appl. No.: 13/495,487

(22) Filed: Jun. 13, 2012

Related U.S. Application Data
(60) Provisional application No. 61/497,095, filed on Jun. 15, 2011.

(51) Int. Cl. A21C 3/04

(52) U.S. Cl. CPC A21C 3/04
USPC 425/376.1

(57) ABSTRACT

A dough extruder for extruding a dough material includes an extrusion section with a piston that is telescopically movable within a hollow piston support toward a barrier disposed at an end of the piston support. The barrier includes apertures that facilitate extrusion of dough material by the piston through the bather. The dough extruder further includes a handle section including a handle and a plurality of gear members coupled to the handle and to the piston, where the handle is movable with respect to the piston support, and a base to support the extrusion section and the handle section. The gear members couple with the handle and piston to facilitate movement of the piston away from the base and toward the bather when the handle is moved in a direction toward the base.

### CROSS-REFERENCE TO RELATED APPLICATION

This application claims priority to and the benefit of U.S. Provisional Patent Application No. 61/497,095, filed Jun. 15, 2011, Attorney Docket No. 0621.1892P, entitled “Dough Extruder” the entire disclosure of which is incorporated herein by reference in its entirety.

### FIELD OF THE INVENTION

The present invention relates to a dough extruder structure that forces dough through an extrusion member.

### BACKGROUND OF THE INVENTION

Various toy products for manipulating dough during play scenarios are known. In addition, certain toy products provide structure for extruding dough through one or more openings in a bather. However, many of the existing dough extruding toy products are hard to operate, sometimes jamming or falling over when force is applied to the toy. Thus, a dough extrusion product is desirable that is easy for a child or young adult to utilize in a play environment.

### SUMMARY OF THE INVENTION

The present invention relates to a dough extruder for extruding a malleable dough material. The dough extruder comprises an extrusion section including a piston that is telescopically movable within a hollow piston support toward a bather disposed at an end of the piston support. The barrier includes apertures that facilitate extrusion of dough material by the piston through the barrier. The dough extruder further comprises a handle section including an arcuate member and a plurality of gear members coupled to the arcuate member and to the piston, where the arcuate member is disposed around at least a portion of the piston support and movable with respect to the piston support, and a base to support the extrusion section and the handle section. The gear members couple with the handle and piston to facilitate movement of the piston away from the base and toward the barrier when the handle is moved in a direction toward the base.

In one embodiment, the arcuate member is an annular member that surrounds the piston support. In another embodiment, the arcuate member is one of at least two arcuate members, wherein each arcuate member is disposed around at least a portion of the piston support.

In another embodiment the plurality of gears is at least three gears. In some embodiments, each of the at least three gears may be coupled to a separate arcuate member. In other embodiments, the at least three gears may be coupled to the annular member in locations equidistant from each other.

### BRIEF DESCRIPTION OF THE DRAWINGS

FIG. 1 illustrates a perspective view of a dough extruder according to an embodiment of the present invention;

FIG. 2 illustrates a side view of the dough extruder of FIG. 1;

FIG. 3 illustrates a top view of the dough extruder of FIG. 1;

FIG. 4 illustrates the piston of the dough extruder of FIG. 1;

FIGS. 5 and 6 illustrate additional perspective views of the dough extruder of FIG. 1, in which the handle of the extruder is at different positions;

FIGS. 7 and 8 illustrate additional side views of the dough extruder of FIG. 1, in which the handle of the extruder is at different positions;

FIG. 9 is an elevational view of different extrusion caps configured for use with the dough extruder of FIG. 1; and

FIG. 10 is a view in perspective of an extrusion cap for use with the dough extruder of FIG. 1.

Like reference numerals have been used to identify like elements throughout this disclosure.

### DETAILED DESCRIPTION OF THE INVENTION

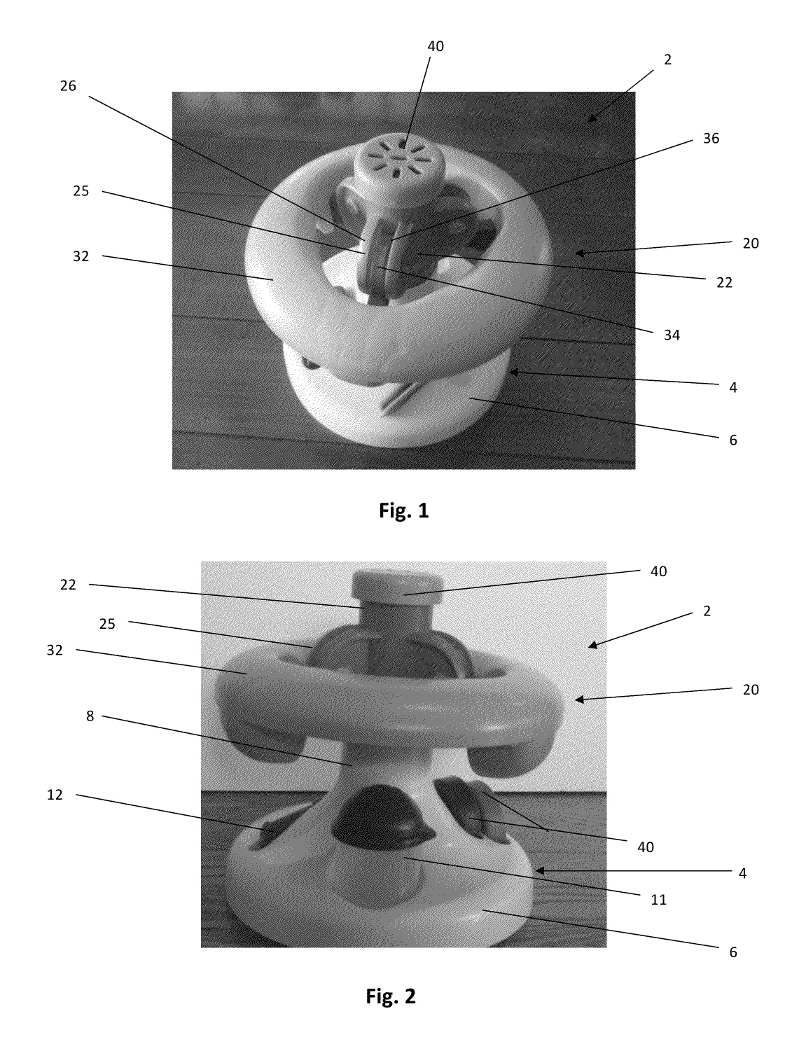

FIGS. 1-10 illustrate a dough extruder 2 according to an example embodiment of the present invention. Referring to FIGS. 1 and 2, the dough extruder 2 includes a base structure 4 and an extrusion member 20 supported by the base structure 4. The components comprising each of the base structure 4 and extrusion member 20, as well as accessories associated with the dough extruder 2, can be constructed of one or more commercial grade plastics and/or any other suitable materials. The dough extruder 2 is further suitably constructed for use with any one or more types of dough material or other types of deformable materials (e.g., modeling clay compound) having characteristics (e.g., pliability, deformability and consistency) that are typical or suitable for using such materials in child play scenarios to deform and shape the materials. In particular, the dough extruder 2 is suitably configured to facilitate extrusion of such dough material (or other deformable material) through a barrier, such as an extrusion cap 40 during use of the extruder 2.

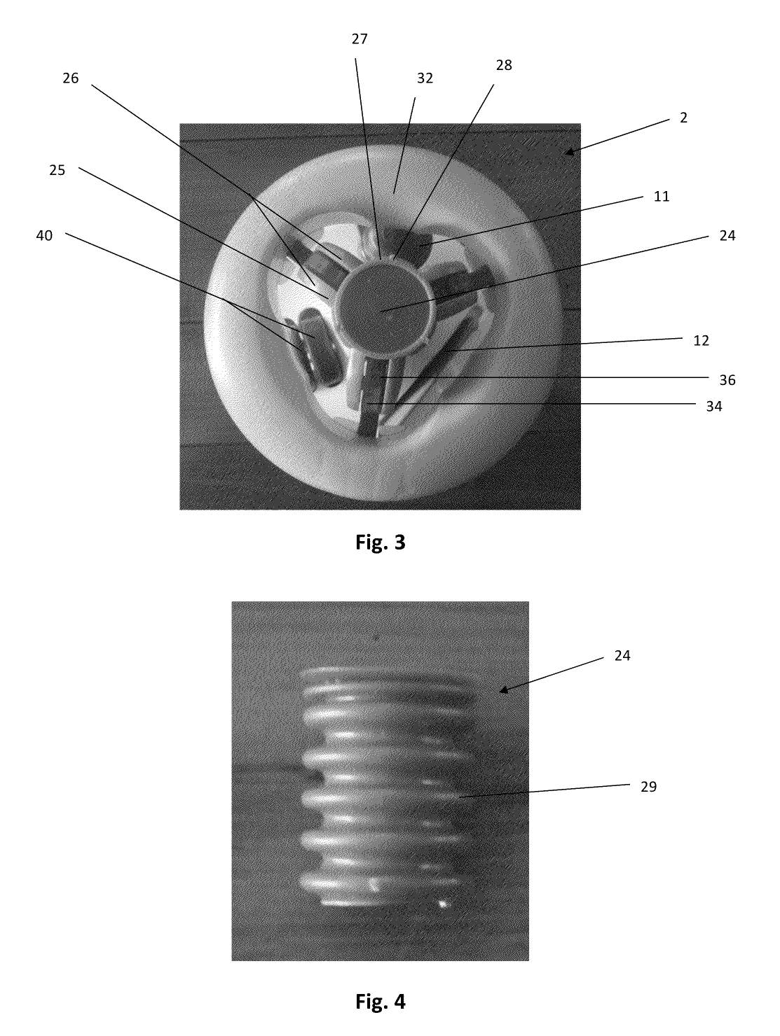

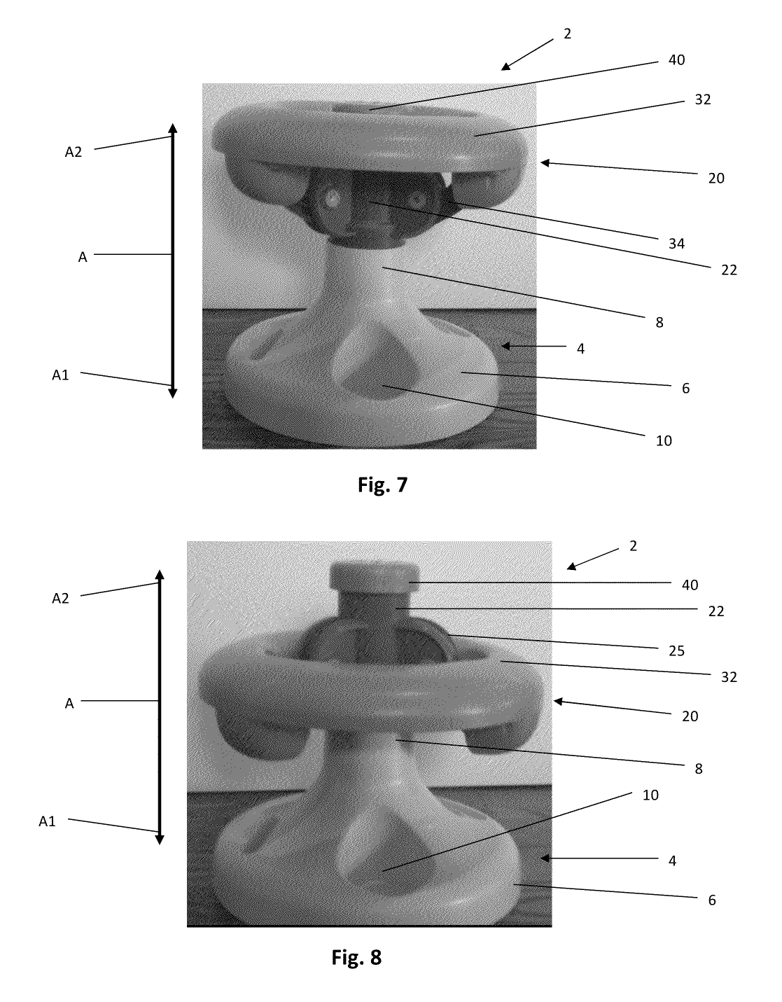

The base structure 4 includes a lower member 6 having a generally circular configuration that is configured to engage a supporting surface. The lower member 6 includes indentations or cavities 10 (also shown in FIGS. 7 and 8) formed within an upper surface of the lower member 6 that are configured to receive and retain (e.g., for storage purposes) accessories that are used with the dough extruder 2. The cavities 10 can be shaped differently so as to store different shaped accessories. For example, as can be seen in FIGS. 2 and 3, one cavity 10 is configured to receive a storage container 11 for dough material to be used with the extruder 2. Another cavity 10 is formed as an elongate slot to receive a utensil 12 (e.g., a putty knife) used to section or form the dough material during play, while still further cavities 10 are provided as slots to receive and retain additional barriers or extruder caps 40 for the extruder 2. Any other suitable numbers and types of further cavities can also be formed in the lower member 6 of the base structure 4 to receive different types of play accessories.

The base structure 4 further includes a generally cylindrical columnar support structure 8 (see FIGS. 2, 7 and 8) that extends from the lower member 6 and is hollow to receive a piston support 22 of the extrusion member 20. The base structure 4 can be configured as a single (e.g., molded) integral unit or, alternatively, the lower member 6 and support structure 8 can be two separate components that are connected to each other in any suitable manner. In addition, while the lower member 6 has a generally circular configuration and the support structure 8 has a generally cylindrical configuration, it is noted that these two components can have any suitable geometric configurations (e.g., square, rectangular, multifaceted, etc.).

The extrusion member 20 includes a piston support 22, a piston 24 and a handle section comprising a handle 32 and gear arms 34. A lower end of the piston support 22 extends within and is supported by the columnar support structure 8 of the base structure 4. The piston support 22 has a generally cylindrical configuration and is further hollow to receive and movably support the piston 24 such that the piston 24 can move telescopically (in directions corresponding to vertical line A as shown in FIGS. 5-8) within the piston support 22. The piston support 22 further includes a plurality of gear support members 25 that extend transversely from the support 22. Each gear support member 25 includes two plates 26 spaced apart from each other so as to form a gap that receive a corresponding gear arm 34 of the handle section (see FIG. 3). As can be seen from the figures (e.g., FIG. 3), the example embodiment includes three gear support members 25 rotationally spaced apart from each other, where each gear support member 25 is spaced from another gear support member 25 at a rotational angle of about 120°. However, any suitable number of gear support members can be provided (e.g., more or less than 3 support members) to facilitate attachment with a corresponding number of gear arms 34 of the handle section.

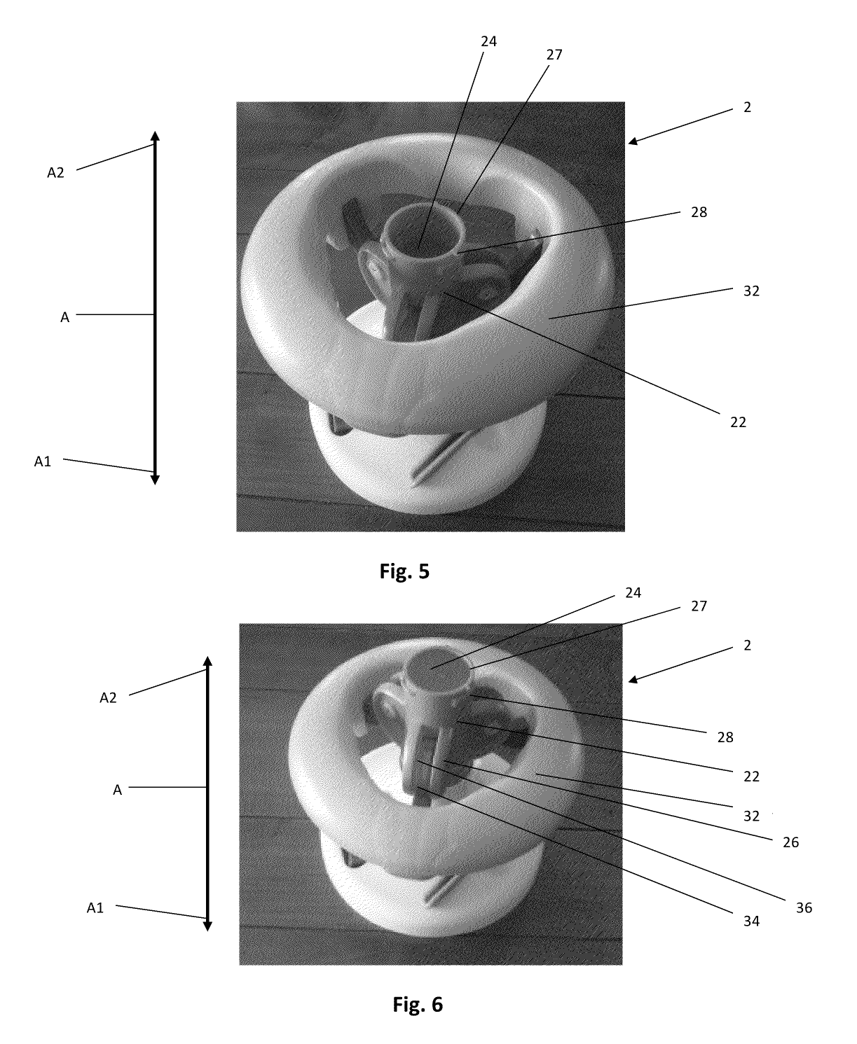

As can be seen in FIGS. 5 and 6, an open upper end 27 of the piston support 22 includes a plurality of raised protrusions 28 spaced apart from each other and disposed along the circumferential exterior surface of the piston support 22. These raised protrusions 28 are configured to engage with corresponding protrusions 44 on a lower lip 43 of each extrusion cap 40 (see FIG. 10) in the manner described below in order to facilitate a releasable locking engagement with an extrusion cap 40 during use of the dough extruder 2.

The handle section may include a generally circular handle 32 having a substantially ring-like or annular configuration so as to surround at least a portion of the piston support 22 when the dough extruder 2 is assembled. In some embodiments, such as those depicted in FIGS. 1-3 and 5-8, handle 32 entirely surrounds piston support 22, but in other embodiments, handle 32 only partially surrounds piston support 22 (i.e., handle 32 may be generally annular shaped, but handle 32 may be formed from multiple parts or pieces with gaps therebetween). Regardless of the shape of handle 32, at least a portion of the piston support may extend through the opening of the generally annular shaped handle 32 when dough extruder 2 is assembled.

As best seen in FIGS. 1, 3, and 6, a plurality of gear arms 34 are connected at spaced apart locations to lower surface portions of the handle 32 and extend inwardly toward the piston support 22. In particular, the gear arms 34 are circumferentially spaced from each other at about 120° along the handle 32 and are oriented and suitably dimensioned such that each gear arm 34 extends within the gap between the two plates 26 of a corresponding gear support member 25 of the piston support 22 (see, e.g., FIG. 3).

Each gear arm 34 is rotatably secured at a first end to a corresponding connection point at a lower portion of the handle 32 and is further rotatably secured at a second end to the plates 26 of the gear support member 25. The rotatable connection of the gear arms 34 at each end to both the handle 32 and the gear support members 25 facilitates movement of the handle 32 in directions corresponding with the axial direction of the piston support 22 (i.e., in directions corresponding to vertical line A as shown in FIGS. 5-8). The second end of each gear arm 34 includes a curved edge with a plurality of gear teeth 36 disposed along the curved edge.

Referring to FIG. 4, the piston 24 has a generally cylindrical configuration and is suitably dimensioned to be received within the hollow opening at the upper end 27 of the piston support 22 to facilitate telescopic movement of the piston 24 within the piston support 22 (i.e., movement of the piston 24 in directions corresponding to vertical line A as shown in FIGS. 5-8). The piston 24 further includes a plurality of protrusions or threads 29 disposed circumferentially along the exterior length of the piston 24. Upon complete assembly of the dough extruder 2, the piston threads 29 engage with the gear teeth 36 of the gear arms 34 of the handle section such that movement of handle 32 (i.e., in directions corresponding with vertical line A as shown in FIGS. 5-8) results in a corresponding movement but in an opposite direction of the piston 24. In particular, a downward movement of the handle (i.e., in a direction that corresponds with arrow A1 as shown in FIGS. 5-8, which is toward the lower member 6 of the base structure 4) results in a corresponding upward movement of the piston 24 (i.e., in a direction that corresponds with arrow A2, which is away from the lower member 6 of the base structure) due to the rotational movement of each gear arm 34 with respect to the handle 32 and piston support plates 26 and also the engagement of the gear teeth 36 with the piston threads 29. In contrast, upward movement of the handle (i.e., in a direction corresponding with arrow A2 as shown in FIGS. 5-8) results in a corresponding downward movement of the piston 24 (i.e., in a direction corresponding with arrow A1 as shown in FIGS. 5-8) due to the rotational movements of the gear arms and engagement between gear teeth 36 and piston threads 29.

As may be best illustrated in FIGS. 5-8 (and in particular, FIGS. 5 and 6, in which the extrusion cap 40 is removed from the end of the piston support 22), when the handle 32 is at its uppermost position with respect to the piston support 22 (i.e., when the handle 32 is moved to its furthest position in a direction corresponding with arrow A2 and as shown in FIGS. 5 and 7), and the piston 24 is at its correspondingly lowermost position within the piston support 22 (i.e., when the piston 24 is moved to its furthest position in a direction corresponding with arrow A1 as shown in FIG. 5), the uppermost end of the piston 24 is separated from the upper or free end 27 of the piston support 22. This provides a gap or space which allows for loading of dough material within the hollow piston support 22 in such space.

When the handle 32 is at its lowermost position with respect to the piston support 22 (i.e., the handle is moved to its furthest position in a direction corresponding with arrow A1 as shown in FIGS. 6 and 8), and the piston 24 is at its uppermost position (i.e., the piston is moved to its furthest position in a direction corresponding with arrow A2), the upper end of the piston 24 is substantially coplanar with the upper end of the piston support 22 (see FIG. 6). As described below, the movement of the handle 32 toward its lowermost position (i.e., in the direction corresponding with arrow A1) forces the piston 24 upward and movement of dough material within the space of the hollow piston support 22 toward and through the extrusion cap 40.

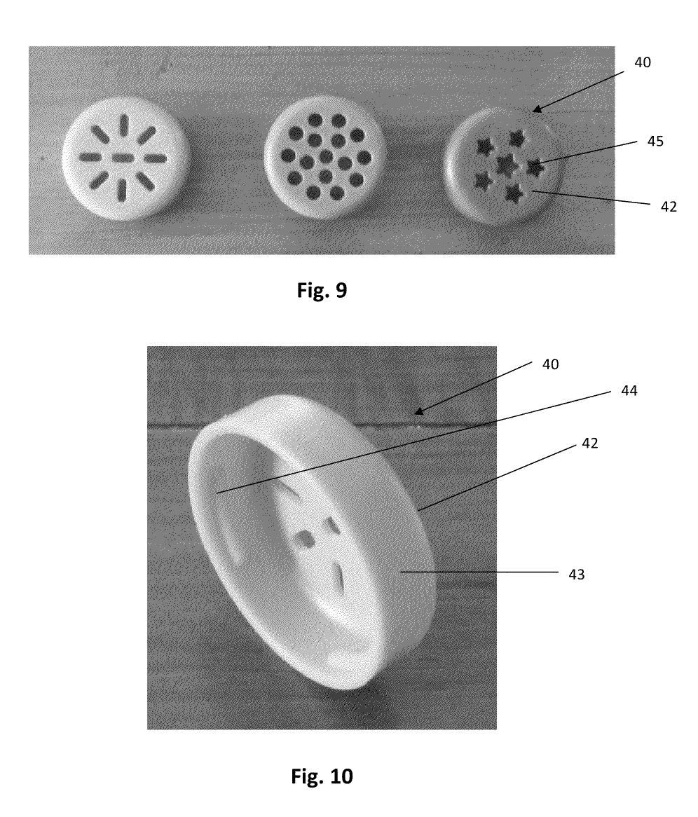

Referring to FIGS. 9 and 10, each extrusion cap 40 includes an upper surface 42 and a lower lip 43 extending from the upper surface 42, where the cap 40 is suitably dimensioned such that the lower lip 43 fits around the upper end of the piston support 22. As noted above, an inner surface portion of the lower lip 43 of each extrusion cap 40 includes protrusions 44 that engage with corresponding protrusions 28 of the piston support 22 when the extrusion cap 40 is secured on the piston support 22. In particular, the extrusion cap 40 may be placed on the upper end of the piston support 22 and rotated in one direction (e.g., a clockwise direction as viewed in FIGS. 1 and 3) to engage the protrusions 44 of the extrusion cap 40 with the protrusions 28 of the piston support 22 to lock the extrusion cap 40 to the piston support 22. Rotation of the extrusion cap 40 in the opposite direction (e.g., a counter-clockwise direction as viewed in FIGS. 1 and 3) results in release of the locking engagement such that the extrusion cap 40 can be separated and removed from the piston support 22. Alternatively, cap 40 may engage piston support 22 through a snap fit or any other desirable manner.

Each extrusion cap 40 further includes a plurality of spaced apart apertures 45 extending through the upper surface 42 of the cap 40. Three extrusion caps 40 are depicted in FIG. 9, where each cap 40 has different patterns of spaced apart apertures 45, and the apertures 45 further have different geometric designs (e.g., circular apertures, elongated apertures, star-shaped apertures, etc.). Other extrusion caps 40 can also be provided having any suitable number (e.g., one or more) and/or pattern of apertures, where the apertures can have any selected shapes (with any single extrusion cap having apertures with the same or different shapes). The orientation, shape, alignment, etc. of the apertures 45 provides a corresponding orientation, shape, alignment, etc. for dough material that is extruded through the apertures 45.

In operation, the handle 32 of handle section 30 is moved in an upward direction (i.e., in a direction corresponding with arrow A2 as shown in FIGS. 5-8), resulting in a downward movement of the piston 24 (i.e., movement in direction corresponding with arrow A1 as shown in FIGS. 5-8) within the piston support 22 to provide a gap or space within the hollow piston support 22 between the upper end of the piston 24 and the upper end 27 of the piston support 22 (as shown in FIG. 5). This gap or space is filled with dough material, and an extrusion cap 40 is selected for the extrusion operation. The selected extrusion cap 40 is then secured in the releasable locking connection with the upper end of the piston support 22. This locking connection prevents the extrusion cap 40 from being removed from the piston support 22 during extrusion of dough material through the upper surface apertures 45 of the cap 40.

Downward movement of the handle 32 results in upward movement of the piston 24 (i.e., movement of the piston 24 in direction that corresponds with arrow A2 as shown in FIGS. 5-8), which in turn forces dough material within the piston support 22 toward and through the apertures 45 of the extrusion cap 40. After extrusion of dough material through the extrusion cap 40, the handle 32 can be moved back to an upward position, the extrusion cap 40 removed from the piston support 22, and more dough material can be loaded within the piston support. The user can use the same extrusion cap 40 or a different extrusion cap 40 (in the event the user desires to extrude different shapes of dough material from the extruder 2). The sequence of operations described above can then be repeated as often as desired to provide further extrusion of dough material from the extruder 2.

The annular configuration of the handle 32 facilitates gripping of the handle during use at one or more different rotationally spaced locations with respect to the piston support 22 of the extruder 2. This allows one or more users (e.g., one or more children) to easily grip the handle 32 at one or more different circumferentially spaced locations along the handle 32 to initiate upward or downward movements of the handle 32. In addition, the rotational spacing of the plurality of gear members along the piston support 22 and handle 32, which may be approximately equidistant or 120° rotational spacing between gear support members 25 and gear arms 34, provides a generally uniform rotational motion of each gear arm 34 despite application of force at different locations along the handle 32, and this provides for relatively smooth operation and minimization of jamming or binding of the gearing mechanism during movement of the handle 32.

It is noted that handle 32 can have any other suitable configuration as an alternative to the annular or ring-like configuration as described above and shown in the drawings. For example, the handle that moves the piston can comprise a curved or arc shaped member (e.g., a handle having a “C” shape) that surrounds a portion of the piston support and is coupled to a plurality of gear arms that drive the piston in an upward direction in response to the handle being forced in a downward direction. Alternatively, the handle can include a plurality of cooperating handle members, where each handle member is coupled with one or more gear arms that drive the piston in an upward direction in response to the handle members being forced in a downward direction. Preferably, the handle is configured so as to couple with at least two rotationally spaced gear arms that cooperate to drive the piston in response to movement of the handle.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. An extruder for extruding a dough material, the extruder comprising:
an extrusion section comprising:
a piston support;
a bather disposed at an end of the piston support and including apertures; and
a piston telescopically movable within the piston support toward the barrier, the piston configured to facilitate extrusion of dough material through the barrier;
a handle section comprising:
an arcuate member disposed around at least a portion of the piston support and movable with respect to the piston support; and
a plurality of gear members coupled to the arcuate member and to the piston, and
a base to support the extrusion section and the handle section, wherein the gear members couple with the arcuate member and piston to facilitate movement of the piston away from the base and toward the barrier when the arcuate member is moved in a direction toward the base.

2. The extruder of claim 1, wherein the arcuate member is an annular member that surrounds the piston support.

3. The extruder of claim 1, wherein the arcuate member comprises at least two individual arcuate members, wherein each individual arcuate member is disposed around at least a portion of the piston support.

4. The extruder of claim 4, wherein each of the individual arcuate members is coupled to a separate gear member.

5. The extruder of claim 1, wherein the gear members are angularly spaced apart from each other such that all of the gear members are equidistant from each other.

6. The extruder of claim 1, wherein the piston support has a interior cross sectional area which is substantially filled by the piston, such that the piston remains telescopically movable with respect to the piston support while preventing dough material from moving past the piston in the piston support.

7. The extruder of claim 6, wherein the piston support is cylindrical.

8. An extruder for extruding a dough material, the extruder comprising:
an extrusion section comprising:
a piston support;
a bather disposed at an end of the piston support and including apertures; and
a piston telescopically movable within the piston support toward the barrier, the piston configured to facilitate extrusion of dough material through the barrier;
a handle section comprising:
an annular member that surrounds the piston support and is movable with respect to the piston support; and
a plurality of gear members coupled to the annular member and to the piston, and
a base to support the extrusion section and the handle section, wherein the gear members couple with the annular member and piston to facilitate movement of the piston away from the base and toward the bather when the handle is moved in a direction toward the base.

9. The extruder of claim 8, wherein the gear members are angularly spaced apart from each other, such that all gear members are equidistant from each other.

10. The extruder of claim 9, wherein the plurality of gear members comprises three gear members angularly spaced 120 degrees apart.

11. The extruder of claim 8, wherein the gear members are rotatably coupled to the annular member.

12. The extruder of claim 8, wherein the gear members are movably coupled to the piston.

13. The extruder of claim 12, wherein the gear members include teeth configured to movably couple the gear member to the piston.

14. The extruder of claim 13, further comprising:
a plurality of support members coupled to an exterior of the piston support and configured to facilitate the coupling of the gear members to the piston, each support member including two plates spaced apart from each other so as to form a gap for receiving one of the plurality of gear members, wherein the gear members and the plates are configured to allow the teeth to move the piston.

15. The extruder of claim 8, wherein the piston is at an uppermost position when the handle section is in a lowermost position, and when the piston is in its uppermost position, an upper end of the piston is substantially coplanar with an upper end of the piston support.

16. The extruder of claim 8, wherein the piston is at a lowermost position when the handle section is in an uppermost position, and when the piston is its lowermost position, an uppermost end of the piston is separated from an upper end of the piston support, such that a gap is formed therebetween.

17. An extruder for extruding a dough material, the extruder comprising:
an extrusion section comprising:
a piston support;
a bather disposed at an end of the piston support and including apertures; and
a piston telescopically movable within the piston support toward the barrier, the piston configured to facilitate extrusion of dough material through the barrier;
a handle section comprising:
an arcuate member disposed around at least a portion of the piston support and movable with respect to the piston support; and
at least three gear members coupled to the arcuate member and to the piston, and
a base to support the extrusion section and the handle section, wherein the gear members couple with the arcuate member and piston to facilitate movement of the piston away from the base and toward the bather when the handle is moved in a direction toward the base.

18. The extruder of claim 17, wherein the barrier is removably securable to the piston support.

19. The extruder of claim 17, wherein the barrier and the piston support include threads configured to removably secure the bather to the piston support.

20. The extruder of claim 17, wherein the base includes at least one storage compartment.
